(19) United States
(12) Patent Application Publication
(10) Pub. No.: US 2005/0272410 A1
(43) Pub. Date: Dec. 8, 2005

(54) Monitoring system for use status of computer apparatus

(75) Inventor: Yung-Che Chen, Taipei (TW)

Correspondence Address: BACON & THOMAS, PLLC, 625 SLATERS LANE, FOURTH FLOOR, ALEXANDRIA, VA, 22314, US

(73) Assignee: INVENTEC CORPORATION, Taipei (TW)

(21) Appl. No.: 10/859,229

(22) Filed: Jun. 3, 2004

(51) Int. Cl. H04Q 7/20

(52) U.S. Cl. 455/414.1; 455/466; 455/566

(57) ABSTRACT

The present invention discloses a monitoring system for use status of a computer apparatus, which includes a monitoring program and a data storage medium being installed in the monitoring system and a video device controlled by the monitoring program being set on a proper position of the computer apparatus, for performing the steps of determining whether any pre-set event occurred so as to trigger the video device to photograph/or film, storing the photographed/or filmed image data in the data storage medium, recording and storing all of the executed operating record data in the data storage medium, and then transmitting the stored image data outwardly to an electronic device through a network scheme.

### BACKGROUND OF THE INVENTION

The world we lived has been entered a new era with rapidly developed information and electronic industries. Every kind of high-tech products derived from microcomputer rapidly progresses, and also provides people with hugely convenient daily life. With the continuous developing and improving of different kinds of electronic technologies, the use requirement for consumer electronic products is also raised. Accordingly, every information and electronic factory is performing continuous research and refinement to its products and peripheral devices/apparatuses for providing people with universal service having more convenience, effectiveness, and personification. This is an important index to estimate whether one of the related technology industries is far ahead of them.

The keen competitions between persons of the same business led to critical phenomenon of distributed business spy. Especially for high-tech industries, employee is commanded by employer to be recruited as a RD technician of other company so as to steal research secrets. Accordingly, people will worry about whether his computer is improper used by someone or data stored in the computer are malevolently modified or stole.

It is always lack of evidence to recognize the unauthorized person and point his criminal evidence out even this situation happened. Accordingly, how to develop a monitoring system capable of truly monitoring the detailed record of illegal use is indeed an important and urgent subject that is necessary to be solved for related industries in the present.

### SUMMARY OF THE INVENTION

According to the described deficiencies of the prior art and referring to the ubiquitous property of network scheme, the inventor had made long-term researches and experiments to finally develop “a monitoring system for use status of a computer apparatus” of the present invention. The submitting of the present invention for patent application is hopefully contributed to the public.

It is one purpose of present invention to enable the owner of computer apparatus, for example, notebook computer, to acquire the unauthorized user's facial image or body form by using the monitoring program to auto-photograph or auto-film, if the unauthorized user is illegally operating the computer apparatus even the owner left the computer apparatus for handling something else. Meanwhile, the recorded or photographed image data are transmitted to the owner's mobile phone for immediate notification by mobile telecommunication network. In addition, the recorded or photographed image data can be transmitted to the owner's personal computer by internet network to acquire the image evidence of the unauthorized user whom is using the computer apparatus illegally.

It is another purpose of the present invention to enable the owner of the computer apparatus to acquire detailed operating record, such as which kind of program is executed, deleted, stored, or downloaded, of the unauthorized user whom is illegally using the computer apparatus by the use of the monitoring system to store every operating record, if a criminal is using the computer apparatus without allowance even through the owner left the computer apparatus for handling something else

The above and other objects, features and advantages of the present invention will become apparent from the following detailed description taken with the accompanying drawings.

### BRIEF DESCRIPTION OF THE DRAWINGS

FIG. 1 is a schematic diagram showing the data transmitting of computer apparatus through network scheme in accordance with the present invention.

FIG. 2 is a schematic diagram showing the hardware and software schemes of the computer apparatus in accordance with the present invention.

FIG. 3 is a schematic, flow diagram showing the determining and performing of the present invention when the monitoring program is enabled.

### DETAILED DESCRIPTION OF THE PREFERRED EMBODIMENT

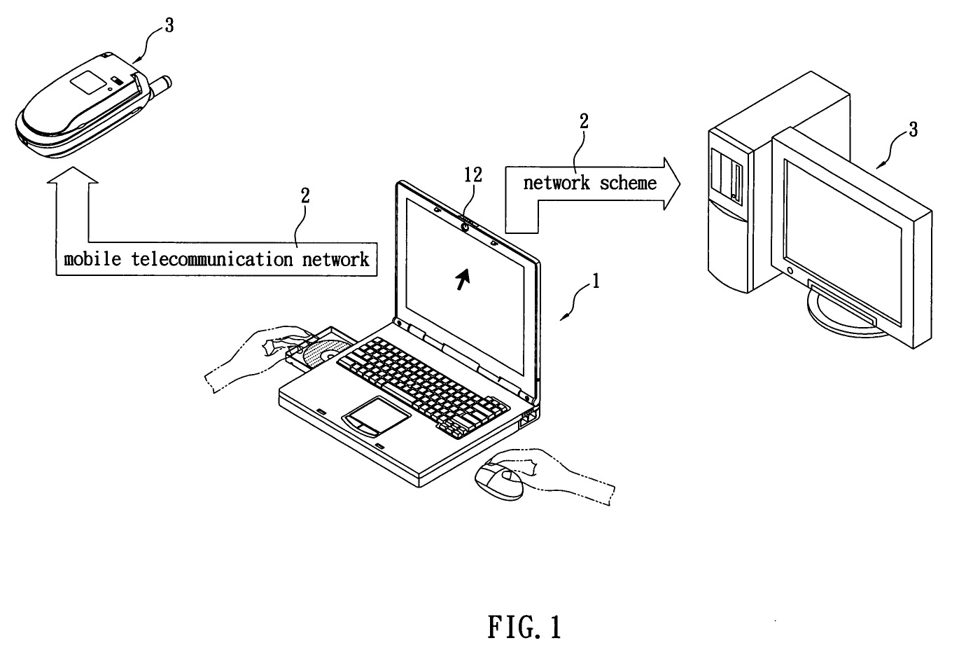

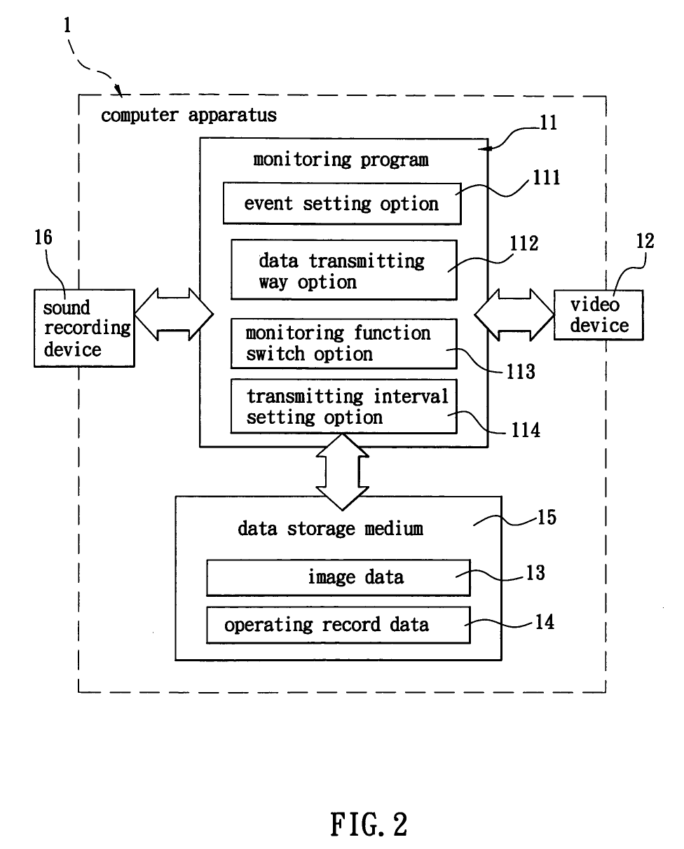

The present invention is a monitoring system for use status of a computer apparatus. Please refer to FIG. 1 and FIG. 2, in which a monitoring program 11 and a data storage medium 15 are installed in a computer apparatus 1, for example, notebook computer or desktop computer. A video device 12, for example, web camera, which is controlled by the monitoring program 11 is located in a proper position of the computer apparatus 1, wherein several kinds of events are pre-set in the monitoring program 11, so that when any event occurred the video device 12 will be triggered to photograph/or film immediately, and the photographed/or filmed image data 13 will be stored in the data storage medium 15, and entire executed/or operated operating record data 14 of the computer apparatus 1 will be recorded at the same time. The recorded operating record data are then stored in the data storage medium 15, for example, hard disk. Finally, the image data 13 are outwardly transmitted to a pre-determined electronic device 3, such as mobile phone, notebook computer or Personal Digital Assistant, through a network scheme 2. Accordingly, any illegal event, for example, criminal's facial image and entire operation records, of the unauthorized operation on the computer apparatus 1 is monitored and recorded as long as the owner of the computer apparatus 1 enabled the present invention before he left the seat.

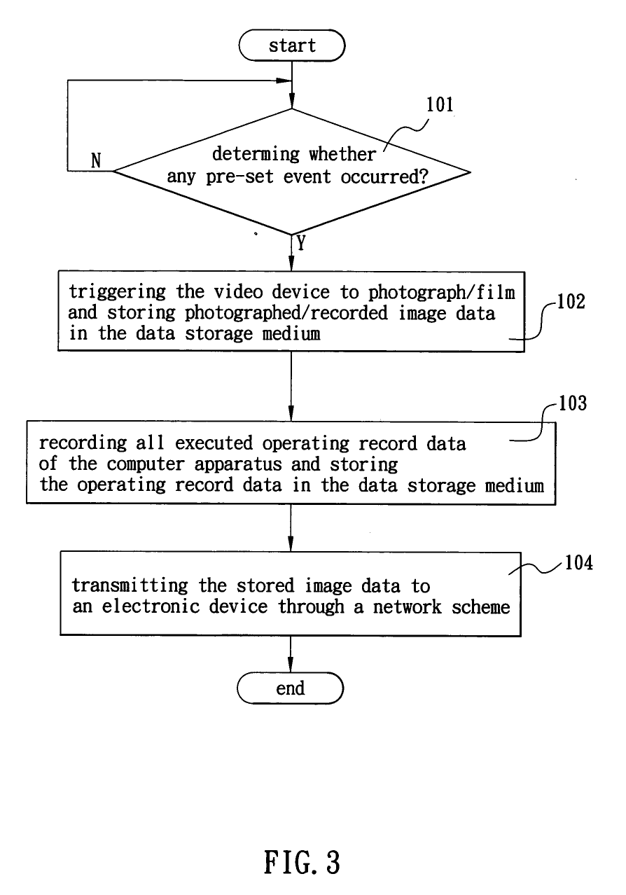

In the present invention, the monitoring program 11 is an important mechanism for executing operation, wherein the program code of the monitoring program 11 can be written by any programming language, the method of determining whether a hardware device is enabled, such as whether CD-ROM is opened, is not a key-point of the present invention as long as the major purpose, namely, monitoring and recording, is achieved by the monitoring program. Accordingly, the redundant description of the program code is omitted here. The determining and performing processes of the monitoring program 11 of the present invention are purely detailed described as follows (with reference to FIG. 3):
(101) Firstly, determining whether any event occurred? If “yes”, the next step (102) is then performed, if “no”, the (101) step is repeated;
(102) Thereafter, the video camera 12 is triggered to photograph/film, the photographed/recorded image data 13 are stored in the data storage medium 15;
(103) Then, all executed operating record data 14 of the computer apparatus 1 are recorded, and the operating record data 14 are stored in the data storage medium 15;
(104) Finally, the stored image data 13 are outwardly transmitted to an electronic device 3, for example, mobile phone, through a network scheme 2, for example, mobile telecommunication network.

Please refer to FIG. 1 and FIG. 2, in the present invention the network scheme is a mobile telecommunication network, the electronic device 3 is a mobile phone, so that the image data 13 can be transmitted to the mobile phone by the use of Short Message Service (SMS) through the mobile telecommunication network. Thus, any unauthorized person whom is operating the computer apparatus 1 will be recognized as long as the user carried the mobile phone on his person.

In addition, the network scheme 2 can be an internet network and the electronic device 3 can be a personal computer so as to enable the monitoring program 11 to transmit the image data 13 or the operating record data 14 to the personal computer through the internet network by the use of package, for example, E-mail. Accordingly, the owner of the computer apparatus 1 will acquire powerful proofs of unauthorized operation and destruction to the computer apparatus 1 or entire acting records of purposely modifying/deleting its interior data, file or program by someone.

Moreover, a data transmitting way option 112 is set on the monitoring program 11 so as to enable the owner of the computer apparatus 1 to set (or pick) the way of transmitting the image data 13 to the mobile phone through the mobile telecommunication network or to a personal computer by E-mail, wherein the image data 13 can be set as singular data be outwardly transmitted or the operating record data 14 can be set to be transmitted as well.

As described above, if any event is accomplished, namely, any event occurred, the video device 12 will be triggered immediately to photograph or film. But, what is the event? For example, if a power button is pressed when the computer apparatus 1 has a power off state, this kind of condition can be treated as an event. In addition, if the computer apparatus 1 is a notebook computer, opening of its monitor screen can be treated as an event as well. Event can be pressing of keyboard, opening of CD-ROM, disk inserting of soft-disk, touching of mouse, or moving of cursor of the computer apparatus 1 no matter it has power on state or standby power state. Accordingly, an event setting option 111 may be set in the monitoring program 11, so as to enable the owner of the computer apparatus 1 to set (or pickup) every proper event for triggering the video device 12.

In the present invention, please refer to FIG. 1, the main purpose of the video device 12 is to acquire facial image and body form of the unauthorized user of the computer apparatus 1, no matter the acquired data are pictures or films. In addition, a sound recording device 16, which is controlled by the monitoring program 11, is located on a proper location of the computer apparatus 1 so that when any event occurred not only the video device 12 will be triggered to photograph or film immediately, but the sound recording device 16 will be triggered to record sound at the same time, wherein the recorded sound is also stored in the data storage medium 15. Accordingly, not merely the facial image of the unauthorized user of the computer apparatus 1 is acquired, sound of the user, and communication between the user and accomplice are recorded as well so as to intensified collection of criminal evidences. Thus, a monitoring function switch option 113 is set in the monitoring program 11 so as to enable the video device 12 to record/or photograph and to determine whether the sound recording device should be enabled simultaneously.

If any event occurred, the video camera 12 will be enabled to photograph/or film and to record the entire operated process of the computer apparatus 1 to the data storage medium 15. At this moment, the owner of the computer apparatus 1 may desires to immediately, or post-event for lack of urgency, recognize the unauthorized person whom is illegally operating the computer apparatus 1. Accordingly, a transmitting interval setting option 114 is set on the monitoring program 11 so as to enable the owner of the computer apparatus 1 to pre-set an interval of transmitting the image data 13 and the operating record 14. For example, the photographed or recorded image is outwardly transmitted right away or after a fixed interval, such as 1 minute or 3 minutes, if somebody touched the computer apparatus 1 or before the computer apparatus 1 is ordered to shut down.

In the present invention two additional items, namely, “login name” and “password” may be set on the monitoring program 11 for enabling identification of the monitoring program 11. In addition, the computer apparatus 1 can be a notebook computer, a Personal Digital Assistant (PDA), Web Pad, or any network accessible information apparatus that is equipped with the function of wireless accessing network.

While the invention has been described by means of specific embodiments, numerous modifications and variations could be made thereto by those skilled in the art without departing from the scope and spirit of the invention set forth in the claims.

1. A monitoring system for use status of a computer apparatus, in which a monitoring program and a data storage medium are installed in the monitoring system, a video device which is controlled by the monitoring program is set on a proper position of the computer apparatus, wherein several kinds of events are pre-set in the monitoring program, so as to perform the following steps as the monitoring program is enabled:
determining whether any pre-set event occurred, if “yes”, the video device is triggered and started to photograph/or film, and the photographed or filmed image data are stored in the data storage medium as well;
recording entire executed operating record data of the computer apparatus and storing the operating record data in the data storage medium; and
transmitting the stored image data outwardly to an electronic device through a network scheme.

2. The system of claim 1, wherein if the programming program does not determine the occurrence of any pre-set event, the determining step is then performed again for determining whether any pre-set event occurred.

3. The system of claim 1, wherein the electronic device is a mobile phone and the network scheme is a mobile telecommunication network so as to enable the monitoring program to transmit the image data to the mobile phone through the mobile telecommunication by using a short message service (SMS).

4. The system of claim 1, wherein the electronic device is a personal computer and the network scheme is an internet network so as to enable the monitoring program to transmit the image data to the personal computer through the internet network by using a packet.

5. The system of claim 1, wherein a sound recording device which is controlled by the monitoring program is set on a proper location of the computer apparatus so that when any pre-set event occurred the sound recording device will be triggered by the monitoring program to record immediately and the recorded sound will be stored in the data storage medium.

6. The system of claim 1, wherein a login name item and a password item are set on the monitoring program for enabling identification when the monitoring program is enabled.

7. The system of claim 2, wherein an event setting option is set on the monitoring program so as to enable the monitoring program to determine the occurrence of any pre-set event according to a setting of the event setting option.

8. The system of claim 1, wherein a data transmitting way option is set on the monitoring program so as to enable the monitoring program to determine a way of transmitting a recorded data according to a setting of the data transmitting way option.

9. The system of claim 1, wherein a monitoring function switch option is set on the monitoring program so as to enable the monitoring program to determine a way of collecting data according to a setting of the monitoring function switch option.

10. The system of claim 1, wherein a transmitting interval setting option is set on the monitoring program so as to enable the monitoring program to decide a timing to outwardly transmit the data according to a setting of the transmitting interval setting option.
